(19) United States
(12) Patent Application Publication
(10) Pub. No.: US 2002/0126038 A1
(43) Pub. Date: Sep. 12, 2002

(54) Vehicle sound and alerting system

(76) Inventor: Kevin Kroculick, Milton, PA (US)

Correspondence Address: Kevin Kroculick, 427 Park Ave., Milton, PA, 17847, US

(21) Appl. No.: 09/903,074

(22) Filed: Jul. 11, 2001

Related U.S. Application Data
(60) Provisional application No. 60/273,989, filed on Mar. 7, 2001.

(51) Int. Cl. G01S 7/42

(52) U.S. Cl. 342/20; 342/52; 342/70; 342/89; 455/212; 455/227

(57) ABSTRACT

The Vehicle Sound and Alerting System is generally comprised of a conventional automobile stereo system that has police radar detection capabilities. When police radar is detected, the stereo's volume is immediately muted. An audible alert is then outputted through the vehicle's speaker system or a built-in speaker on the control panel, or a combination of both, depending on how the driver has it configured. A visual alert is also produced on the control panel, which displays the band of radar that was encountered, and its relative signal strength. The radar detector receives signals from the vehicle's antenna and an auxiliary antenna. The auxiliary antenna is attached to the vehicle's grille. This improves the signal reception ability. The present invention eliminates many drawbacks associated with conventional radar detector units, such as their obviousness which has tendency to attract thieves and vandals if left unattended; their inconstant effectiveness caused by impeded reception ability when they are mounted improperly; their bulkiness; and potential to produce visual impairment and distraction.

### BACKGROUND—FIELD OF THE INVENTION

The present invention relates to a vehicle sound and alerting system. More specifically, it relates to the combining of a radar detector of the type that is used for detecting police radar of the sort used in radar speed traps on public roads, with a car stereo system. When the police radar is detected, the stereo volume is muted and an audible warning sound is emitted from the vehicle's speakers.

### BACKGROUND—DESCRIPTION OF THE INVENTION

Typical radar detectors are effective and function properly if the manufacturers instructions are followed. However, there are many drawbacks associated with the use of typical radar detectors. This invention eliminates those associated problems in a convenient, practical, and relatively inexpensive manner.

The bulkiness of conventional radar detectors may be a hindrance to vision, or it may be otherwise undesirable from an esthetic point of view. Also, if a conventional radar detector is left in the vehicle unattended, its obviousness makes it vulnerable to theft. Furthermore, the theft of a radar detector usually results in vandalism to the vehicle.

Of course to reduce the chance of theft, the vehicle's operator can install the radar detector before each trip, then remove and store it after the trip is complete, but this is time consuming and cumbersome.

From a more scientific point of view, microwave frequencies of those used in police radars travel in a straight line. These microwave frequencies will pass through many plastic materials and glass, but will not pass through metal objects or mirrors. Therefore, in order for a radar detector to function properly, the microwave radar transmission must have a favorable path from its transmitter to the receiver.

In the present invention, the radar detector portion of the Vehicle Sound and Alerting System receives signals from the vehicle's antenna. This configuration vastly improves the signal reception ability compared to conventional horn or microstrip antennas associated with conventional radar detector units. The present invention also provides for an additional auxiliary antenna that is attached to the vehicle's grille, further enhancing its signal reception ability.

When a police radar signal is detected, the Vehicle Sound and Alerting System can respond in a variety of ways, depending on how the operator has it configured. The most common response scenario when a police radar signal is detected is the stereo volume is immediately muted, a warning tone momentarily emanates from the vehicle's speakers and a small, built-in speaker located on the control panel, and a momentary visual alert is displayed on the control panel. After several seconds, the stereo resumes its normal operation. The ability of the stereos volume to immediately mute and emit a momentary warning tone from the vehicles speakers, the visual alerts on the control panel, and the enhanced radar reception capability, are key elements to the present invention.

In short, incorporating the radar detector into a car stereo system reduces the potential for theft and its associated vandalism, increases the radar detectors effectiveness, and eliminates the need for a nuisance power cord.

It is imperative to note that radar detectors are not intended to encourage the vehicle's operator to drive faster than the posted speed limit. Radar detectors, when used responsibly, actually make drivers more cognizant of their speed, warn drivers of roadwork construction sites, and produce a feeling of safety and confidence when driving in unfamiliar territory. The present invention is also not intended to encourage the driving of vehicles while playing the stereo in a very loud manner. The present invention is also not a police radar jamming system, as these are illegal in many states.

### BACKGROUND—DESCRIPTION OF PRIOR ART

Many people own radar detectors. However, their frequency of usage has a tendency to fade with time. The reason is because most radar detectors require the operator to plug the power cord into the cigarette lighter, and then mount the unit on the visor, windshield, or dashboard. This is time consuming and frustrating, especially during cold weather conditions. Furthermore, mounting the unit on the dashboard with Velcro ™ is usually permanent, as removing the Velcro™ pad may permanently scare the dashboard surface.

Another common complaint related to conventional radar detectors is that the power cord is unsightly, reduces visibility, and is a distraction.

Of course to reduce the threat of theft, a person can remove and store the radar detector out of view. However, removing the radar detector requires unplugging the power cord, returning the cigarette lighter to its housing, removing the radar detector from its mount, then storing it in a secure place such as the truck or glove compartment.

Conventional radar detectors have other disadvantages. Another drawback is the possibility the audio alert will not be heard over a very loud stereo. When this occurs, the entire use of the radar detector has been negated.

Another drawback is that it is sometimes difficult to mount the detector unit in a convenient place that also provides for good microwave radar reception. Because police radar guns work on the line-of-sight principle, it is necessary to provide for a clear, unimpeded path between the radar detector and the radar emitter. A radar detector that does not have the opportunity to detect the police radar is valueless. The present invention solves the above noted problems associated with conventional radar detector configurations.

Incorporating the radar detector into a conventional car stereo system and providing for integrated circuitry to interface with the stereo portion, and providing for a means to utilize the vehicle's radio antenna also providing for additional auxiliary antenna, has many advantages. This configuration reduces possibility of theft by making the radar detector less obvious. It also makes the radar detector more effective by vastly improving it's signal reception capabilities by utilizing the vehicle's radio antenna and providing for an auxiliary antenna that is mounted on the vehicle's grille. And it ensures that the driver is adequately alerted to the presence of police radar guns by momentarily muting the stereo sound, and producing a visual alert on the control panel. This configuration is also much more convenient and esthetically pleasing than conventional radar detectors because there is no need to mount the detector, which in turn eliminates the disadvantage of having a power cord dangling in the vehicle's cabin. Thusly, drivers are more inclined to utilize the radar detector because of its convenience and ease of use.

With respect to specific prior art, some radar detector models provide for a remote antenna to be located in the vehicle's engine compartment. These models provide for unobstructed exposure to the radar emitters, but again the detectors bulkiness and associated annoying power cord are a disadvantage. U.S. Pat. No. 4,625,210 is a portable radar detector that is attachable and detachable to the rearview mirror. This invention provides for unobstructed exposure to front and rear microwave frequency radar transmissions. However, U.S. Pat. No. 4,625,210 differs from the present invention in that the detector may attract burglars if left unattended, the power cord is unsightly and produces a visual distraction, and the audible alert may not be heard over a loud stereo system.

Several U.S. patents have been granted relating to improvements to car stereo lighting and control/display features. These include U.S. Pat. No. 5,363,122 System For Controlling A Display On A Car Stereo, and U.S. Pat. No. 6,065,868, Temperature Display For A Car Stereo. These patents are of interest, but differ from the present invention.

### SUMMARY OF THE INVENTION

Summarized briefly, the principle object of the present invention is to combine a modem means of detecting highway speed control radar emitters with a typical car stereo system. This combination is known as the Vehicle Sound and Alerting System.

The Vehicle Sound and Alerting System is comprised of a housing adapted for mounting into or under the dashboard of a motor vehicle. The stereo portion consists of an amplifier provided within the housing for receiving, generating, and amplifying audio signals of at least one of an AM/FM tuner, tape player, compact disk player, CB radio, and speakerphone. The radar detector portion is comprised of a typical police radar detecting means for detecting the presence of radar signals. The radar detector portion is electrically integrated into the stereo amplifier portion with electronic interface logic means. Both the interface logic means, radar detector means, and stereo amplifier, communicate with at least one of the vehicle's speakers and a small built in speaker located on the control panel, which is capable of producing audible alerts, and Light Emitting Diodes (LEDs) or a Liquid Crystal Display (LCD) located on the control panel which are capable of providing a visual warning when police radar signals are detected.

A key feature of the Vehicle Sound and Alerting System is that the stereo sound is immediately and automatically muted when police radar signals are detected. Another key element is that it provides for at least one jack input on the housing to receive the auxiliary antenna jack. The auxiliary antenna preferably mounts on the vehicle's grille with adhesive or other bonding means. A standard jack input is also provided on the housing, which receives the vehicle's antenna wire.

When police radar signals are detected, the stereo volume is automatically muted and an audible alarm is emitted, at a preset volume, from the vehicle's speakers. A small built-in speaker is provided on the control panel, which can also emit an audible warning if activated. The built-in speaker, and the vehicle's speakers, can be in conjunction with each other, or independently, to produce the audible alert. LEDs or a LCD on the control panel also provide the driver with a visual alert when police radar is detected. The visual alert means can be used in conjunction with, or independently of the audile alert means.

The radar detector portion communicates with the vehicle's radio antenna and auxiliary antenna located on the vehicle's grille, greatly improving its reception capabilities. The auxiliary antenna is installed through an opening in the vehicle's firewall, and mounted on or near the vehicle's grille with adhesive or other bonding means.

The driver can operate the stereo in combination with, or independently of, the radar portion. Consequently, the driver can choose to only operate the stereo portion while the radar detector portion is deactivated. The driver can also choose to only activate the radar detector portion without utilizing the stereo portion.

### OBJECTS AND ADVANTAGES

Accordingly, the reader will see that a radar detector integrated into a typical car stereo system provides the driver with both stereo and radar detection capability, without the many disadvantages of having an independent radar detector. The radar detector integrated into the car stereo has the following advantages:

The present invention eliminates the need to install/uninstall a radar detector prior to and after each trip.

The present invention eliminates the need for a separate power cord that can be a distraction.

The present invention is much less obvious than a separate, conventional radar detector.

Using the vehicle's antenna increases its radar detection capabilities.

The auxiliary antenna increases its radar detection capabilities.

The present invention reduces the potential for theft and vandalism.

The systems ability to override and automatically mute the stereo amplifier system, and the ability to use the stereo portion or radar detector portion independently, enables each driver to regulate the system as desired.

Radar emitters are usually installed at road construction sites to warn drivers of roadwork. Therefore, the present invention increases driver awareness and safety.

### BRIEF DESCRIPTION OF THE DRAWINGS

While the invention is particularly pointed out and distinctly claimed in the concluding portions herein, a preferred embodiment is set forth in the following detailed description which may be best understood when read in connection with the accompanying drawings, in which:

FIG. 1 shows a schematic block diagram of the invention.

FIG. 2 shows a preferred embodiment of the front panel of the invention.

FIG. 3 shows a preferred embodiment of the auxiliary antenna.

FIG. 4 shows the invention mounted in the dashboard of a typical automobile.

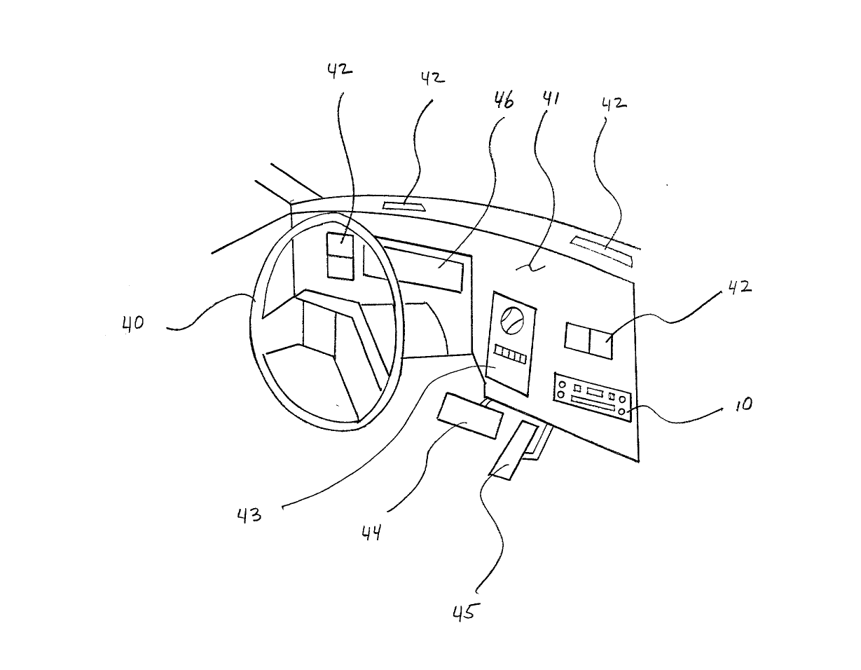

FIG. 5 shows a rear isometric view of the invention.

FIG. 6 shows an isometric view of a typical vehicle with auxiliary antenna installed.

### REFERENCE NUMERALS IN DRAWINGS

1. Housing

2. Speaker wires

3. Constant power connection

6. Accessory power connection

8. Ground connection

9. Built-in speaker

10. Vehicle sound an alerting system control panel

11. Stereo amplifier

12. Radar detector portion

13. Interface/Logic unit

14. Auxiliary antenna jack

15. Vehicle antenna jack

16. Built-in speaker selector

17. Stereo tuner selector

18. Stereo tuner channel indicator

19. FM/AM selector

20. Tone, treble and bass adjustment controls

21. Balance and fade adjustment controls

22. Tape or CD fast forward/reverse control and eject

23. Radar detector visual alert control (on/off)

24. Radar detector audio alert control (on/off)

25. Radar detector signal strength indicator

26. Radar detector signal band indicator

27. False signal reduction

28. Tape or compact disc player

29. Stereo tuner station pre-set selector control

30. Radar detector power/volume control

31. Stereo amplifier power/volume control

32. Auxiliary antenna prong

33. Auxiliary antenna wire

34. Protective sleeve

35. Auxiliary antenna

40. Steering wheel

41. Typical Dashboard

42. Air vents

43. Air control panel

44. Brake Pedal

45. Accelerator pedal

46. Dashboard indicator panel

47. Speaker

50. Typical Vehicle

51. Vehicle Radio Antenna

52. Grille

### DETAILED DESCRIPTION OF THE PREFERRED EMBODIMENTS OF THE DRAWINGS

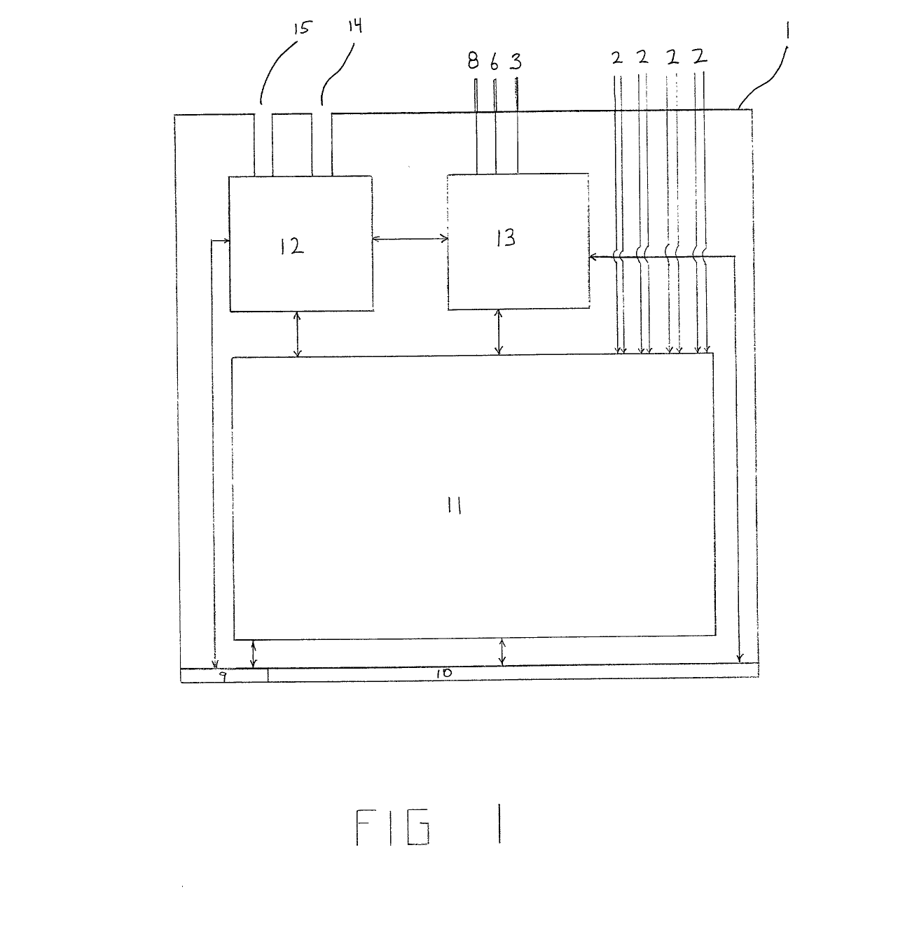

FIG. 1 shows a block diagram of the present invention. The present invention is comprised of a housing 1, speaker wires 2, constant power connection 3, accessory power connection 6, and ground connection 8. The present invention is also comprised of a stereo amplifier 11 which consist of at least an AM/FM tuner, Compact Disc, or tape player, and associated control panel 10. A radio antenna jack 15 that receives the vehicle's antenna wire is also provided. This configuration is similar to that of modern, conventional car stereo systems.

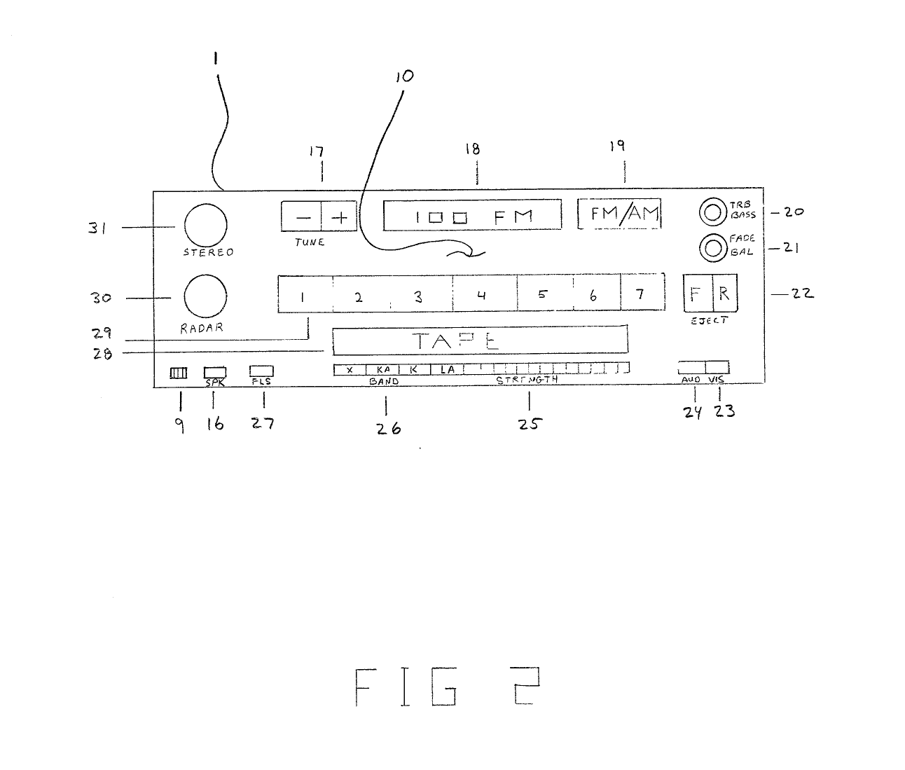

The control panel of the present invention is shown in FIG. 2. The control panel 10 is comprised of buttons, knobs, and selectors, which allows the operator to control the stereo amplifier, such as the power (on/off), volume 31, channel indicator 18, radio present selector buttons 29, balance and fade 21, tuner 17, tone (bass and treble) 20, and the like. It provides for an audiotape or compact disc player 28 and associated controls, such as fast forward and reverse buttons 22. This basic control panel configuration is also similar to that of many conventional car stereo systems.

However, the present invention concerns the addition of a feature to the typical car stereo system that is capable of alerting the vehicle's operator when police radar is detected. This is primarily accomplished by incorporating a radar detector means 12 in the stereo housing and providing for interface and logic means 13, which interfaces with the other circuits and at least one of the vehicle's speakers 47.

Summarized briefly, police radar involves transmitting microwave signals at a target and receiving them back at the transmitter. The speed at which the signal returns relative to the speed at which is was transmitted determines the objects speed. This process is known as the Doppler effect. Police radar is transmitted on three frequencies: X band is 10.525 GHz, K band is 24.150 GHz, and Ka band is 34.360 GHz. Some states also use lasers to determine a vehicle's highway speed. Transmissions at those frequencies will pass through certain kinds of materials that are substantially transparent to them, such as glass and most plastics, but not other kinds of materials, such as metal. In general, microwave frequencies at those frequencies travel in a straight line and must have an unrestricted exposure to the antenna in order for the radar detector to function properly.

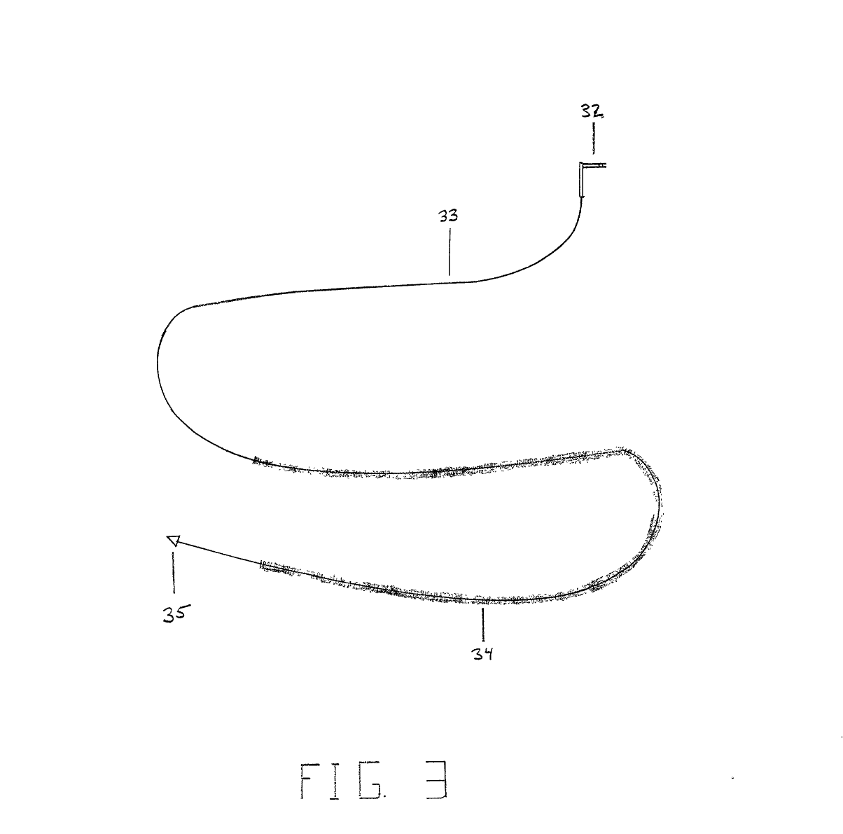

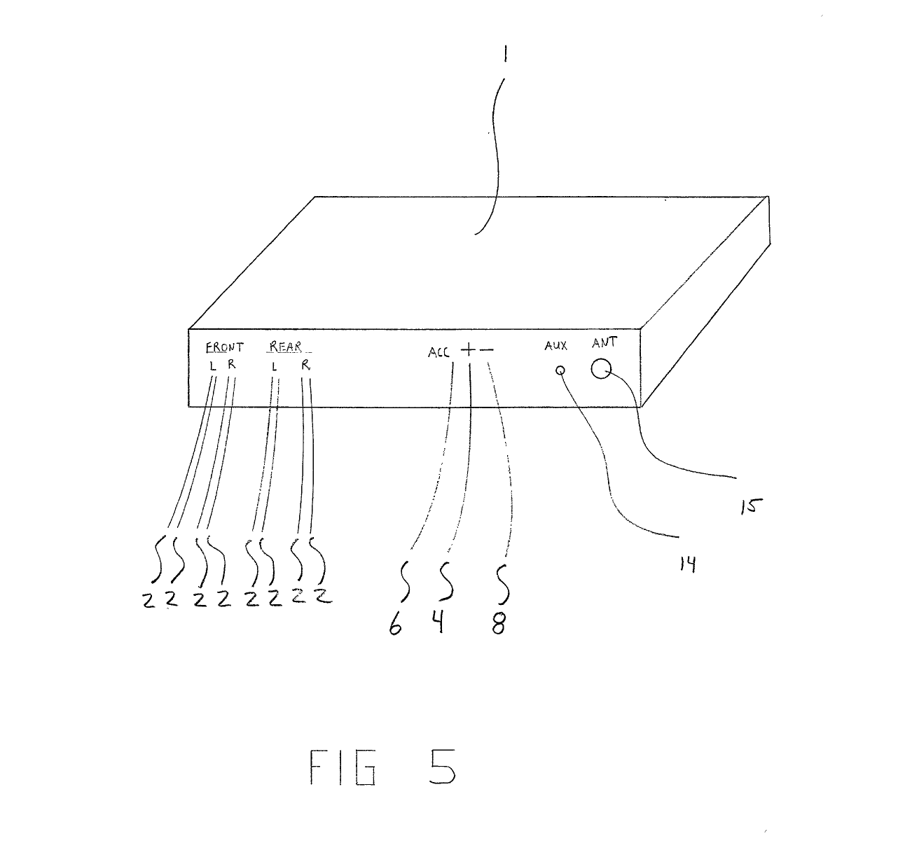

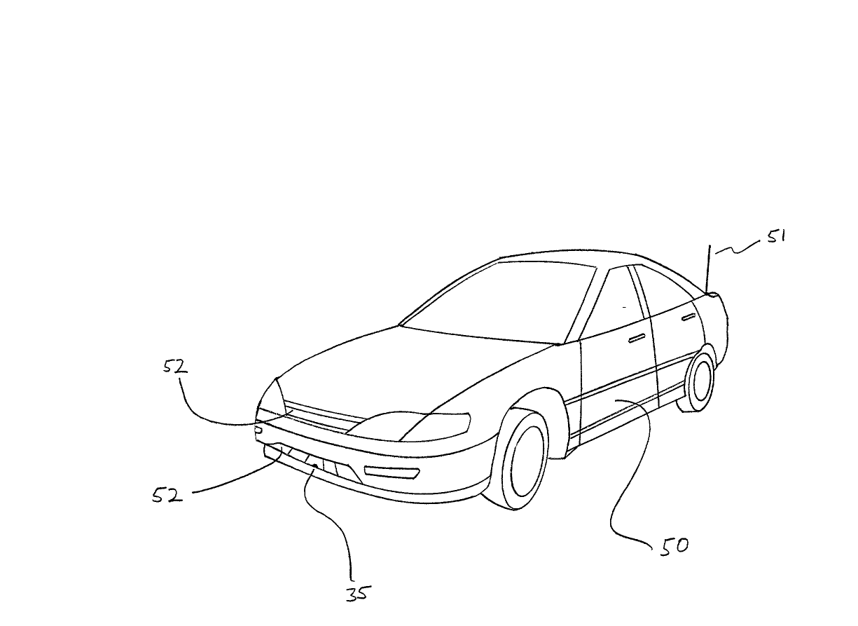

It is these characteristics that are particularly taken advantage of by the present invention. In the present invention, police radar transmissions are received by the radio antenna 51, which are provided on the typical vehicle 50. This configuration is shown in FIG. 6. This configuration vastly improves police radar reception capability. Furthermore, an auxiliary antenna is also provided. The auxiliary antenna is shown in FIG. 3. The antenna 35 is mounted on the vehicle's grille 52 with adhesive or other suitable bonding means and is small enough to be virtually unnoticeable. An antenna wire 33 comprised of a prong 32 and protective sleeve 34 is installed through the vehicle's firewall, and is received by the antenna jack 14 located in the housing. Therefore, providing for a grille mounted auxiliary antenna in conjunction with utilizing the vehicle's radio antenna to receive microwave transmissions maximizes the probability that a police radar signal of interest will be received. This configuration is an improvement over current models. The rear isometric view is shown in FIG. 5. The auxiliary antenna jack 14 is the only substantial difference between the present invention and conventional car stereo systems.

Another key element to the present invention is the manner in which it alerts the driver to the presence of police radar. When the vehicle's radio antenna or the auxiliary antenna receives a police radar transmission, the signal is transmitted to the radar detector portion. The radar detector portion has circuitry similar to that of modem police radar detectors. The circuitry has bandwidths set to the frequencies of interest. If a signal is within the acceptable target range and bandwidth of the true frequency and is encountered at acceptable amplitude, then the radar detector determines that a valid police microwave transmission has been encountered. The radar detector portion then immediately communicates with the interface logic means. The interface logic means then communicates with, and instructs the stereo amplifier portion to immediately alert the driver by implementing conditions that were pre-set by the driver.

The Vehicle Sound and Alerting System can be operated in three primary modes. First, the radar detector portion can be activated while the stereo portion is deactivated, second, the stereo portion can be activated while the radar detector portion is deactivated, and third, the radar detector portion and stereo portion can be operated simultaneously.

As noted above, the driver may elect to operate the radar detector portion while the stereo portion is tuned off. In this mode, the operation of the radar detector is similar to that of a conventional radar detector, but with improved reception capabilities. The driver selects this mode by turning the stereo portion off with the associated power and volume control 31. The driver must also activate the radar detector by selecting the associated radar power and volume control 30.

The radar detector button adjusts the volume of the audible alert that emanates from the vehicle's speakers when police radar is detected. In the event the driver prefers not to utilize the vehicle's speakers, the Vehicle Sound and Alerting System provides a built-in speaker 9. Selecting the speaker control 16 on the control panel activates this speaker. Deselecting the radar audio control 24 prevents the vehicle's speakers from emitting an alert when police radar is encountered. The speaker button also adjusts the built-in speaker volume; continually holding the button in increases the alert sound. When the desired volume is reached, the button is released. This volume setting is retained until the driver makes an adjustment. The built- in speaker has a maximum volume; holding in the speaker button will escalate the volume to its maximum level, but the volume will then gradually decline. This high low cycle is repeatable.

Also in this mode, the driver may also activate the visual alert portion located on the control panel by selecting the visual on/off control 23. These visual alerts are comprised of LCD or LCDs and illuminate when police radar is encountered. These visual alerts display the band type that was transmitted on the band indicator 26, and display its relative signal strength on the strength indicator 25. The visual alert portion may be operated in conjunction with the audio alert, or independent of the audio alert.

Another operating mode consists of utilizing the stereo portion while the radar detector portion is deactivated. This can be accomplished by activating the stereo portion by selecting the appropriate stereo power and volume control 31, while deactivating the radar power volume control 30. The present invention operates as a conventional car stereo in this configuration.

The third mode, and most common mode of operation, is to operate the radar detector portion and stereo portion simultaneously. This mode provides the driver with both conventional car audio sound, and police radar detection capability.

In this mode, the driver selects the radar power and volume control 30 and stereo power and volume control 31. When police radar is detected, the stereo volume momentarily mutes, and an audible warning is sent to the vehicle's speakers 47. The driver may also elect to have the audible warning sent to the built-in speaker located on the control panel. Or the driver may elect to have the audible warning sent to only the built-in speaker, depending on preference. In any case, the stereo resumes its normal play after the momentary audible alert is heard.

In this mode, the driver may also activate the visual alert portion, or only have the visual alert portion activated, depending on preference.

As mentioned above, an auxiliary antenna shown in FIG. 3 is also provided. The auxiliary antenna 35 is mounted on the vehicle's grille. A vehicle in this patent is defined as any type of car, van, truck, motorcycle, four-wheeler or snowmobile.

The auxiliary antenna wire 33 is inserted through the vehicle's firewall, and the prong 32 is inserted the auxiliary antenna jack 14. A typical protective sleeve 34 made of high strength and heat resistant material is provided to eliminate potential damage to the antenna wire. The auxiliary antenna should be used if the vehicle's radio antenna is located in the rear of the vehicle. A rear located antenna does not provide for optimal radar signal detection, as the vehicle's roof could block the signal. Of course the auxiliary antenna must also be used if the vehicle does not have its own radio antenna. The auxiliary antenna can be used as the primary antenna, or in conjunction with the vehicle's radio antenna for exceptional radar detection capability.

Many security systems, garage door openers, etc. can produce false alerts. Consequently, a means to eliminate unwanted audio alerts is provided. When the false signal selector 27 is selected, pre-set signal amplitude must be reached before the alert activates. If the driver chooses not to utilize the radar detector portion, then it can be easily turned-off by making the appropriate selection on the power and volume button 30. Likewise, the radar detector portion can be activated without listening to the stereo.

When the radar detector portion is activated, it can perform a self-test. This entails an internal operational check accompanied by a momentary illumination of the LEDs and a brief audio alert.

The Vehicle Sound and Alerting System is ultimately mounted into, or under the vehicle's dashboard 41, which makes it's use very convenient for the driver. FIG. 5 shows the in-dash configuration. A steering wheel 40, air vent 42, and control panel 43, brake pedal 44, accelerator pedal 45 and dashboard indicator panel are shown for reference.

### Conclusion, Ramification, and Scope

Although preferred embodiments of the invention have been described in the foregoing Detailed Description of the Drawings, it will be understood that the invention is not limited to the embodiments disclosed, but is capable of numerous rearrangements, modifications, and substitution of parts and elements without departing from the spirit of the invention. For example, the stereo portion may include at least a tape or compact disc player. The Vehicle Sound and Alerting System can be of the in-dash or under-dash variety. Certain bands can be eliminated, such as the laser and X bands. Each band can produce a separate audio alert, such as a chirp, ringing, or shrill sound. The switches and buttons may be placed in different positions, or eliminated without affecting the purpose of the assembly and the invention. An anti-theft detachable control face may also be provided. A remote control device may be provided. Accordingly, the present invention is intended to encompass such rearrangements, modifications, and substitutions of parts and elements as fall within the scope and spirit of the claim.

I claim:

1). A vehicle sound and alerting system comprising:
a) a housing adapted for mounting to the dashboard of a motor vehicle;
b) an amplifier provided within said housing for amplifying audio signals;
c) at least one speaker electrically connected to said amplifier for producing audible sounds;
d) means for generating audio signals electrically connected to said amplifier;
e) Radar detector means for detecting the presence of police radar signals provided within said housing;
f) alert means electrically connected to said radar detector means for providing at least one of a visual warning signal and audible warning signal when radar signals are detected; and
g) muting means for reducing the level of sound provided to said at least one speaker from said means for generating audio signal whenever said radar detector means detects the presence of police radar signals.

2). A vehicle sound and alerting system according to claim 1 wherein said housing is mounted in the dashboard of the vehicle.

3). A vehicle sound and alerting system according to claim 1 wherein said housing is mounted underneath the dashboard of the vehicle.

4). A vehicle sound and alerting system according to claim 1 wherein said amplifier is a stereo amplifier.

5). A vehicle sound and alerting system according to claim 1 wherein said amplifier is a stereo tuner.

6). A vehicle sound and alerting system according to claim 1 wherein said a plurality of speakers are mounted as various desired locations within the vehicle.

7). A vehicle sound and alerting system according to claim 1 wherein said plurality of speakers are mounted at various desired locations within the vehicle and at least one speaker is provided within said housing.

8). A vehicle sound and alerting system according to claim 1 wherein said means for generating audio signals is provided within said housing.

9). A vehicle sound and alerting system according to claim 1 wherein said means for generating audio signals consisting of at least one of an AM/FM tuner, tape player, compact disk player CB radio, and speaker phone.

10). A vehicle sound and alerting system according to claim 1 wherein said radar detector means has at least one input provided on said housing adapted to receive an electrical connection from at least one antenna.

11). A vehicle sound and alerting system according to claim 1 further comprising a primary antenna mounted on an upper surface of the vehicle wherein said radar detector means has a first antenna input adapted to receive an electric connection from said primary antenna.

12). A vehicle sound and alerting system according to claim 1 wherein further comprising an auxiliary antenna mounted on a front grille of the vehicle wherein said radar detector means has a second antenna input adapted to receive an electrical connection form said auxiliary antenna.

13). A vehicle sound and alerting system according to claim 1 wherein said alert means provides an audible warning signal to said at least one speaker and wherein said muting means reduces the level of sound provided to said at least one speaker from said means for generating audio signal to a zero output thus allowing the amplifier to amplify only the audible warning signal.

14). A vehicle sound and alerting system according to claim 1 wherein further comprising a display means provided on said housing to display said visual warning signal from said alert means.

15). A vehicle sound and alerting system according to claim 1 further compromising a display means provided on said housing to display information regarding the operation of the vehicle sound system.

16). A vehicle sound and alerting system according to claim 1 further comprising a display means provided on said housing to display said visual warning signal from said alert means and wherein said audible warning signals are simultaneously provided to said at least one speaker.

17). A vehicle sound and alerting system according to claim 1 wherein said means for generating audio signals can be independently turned off while said radar detector means remains in an operating condition.

18). A vehicle sound and alerting system according to claim 1 wherein said radar detector means can be independently deactivated while said means for generating audio signals remains in an operating condition.

19). A vehicle sound and alerting system according to claim 1 wherein the volume of the said means for generating audio alert signal is adjustable.

20). A vehicle sound and alerting system according to claim 1 wherein said means for displaying visual alert means is adjustable.
